(19) United States
(12) Patent Application Publication
(10) Pub. No.: US 2012/0011851 A1
(43) Pub. Date: Jan. 19, 2012

(54) Solar Heat Collector

(76) Inventor: Laurier Lievre, Mundare (CA)

(21) Appl. No.: 13/183,111

(22) Filed: Jul. 14, 2011

Related U.S. Application Data
(60) Provisional application No. 61/364,064, filed on Jul. 14, 2010.

(51) Int. Cl. F03G 6/06; F24J 2/08

(52) U.S. Cl. 60/641.15; 126/698

(57) ABSTRACT

A solar heat collector includes a housing defining an insulated chamber extending from a focusing lens at a solar receiving end to a target glass at a target end forming a boundary wall between the insulated chamber and a target chamber receiving a heat transfer fluid therein. A target object is supported in the target chamber at the focal point of the focusing lens so as to be surrounded by the heat transfer fluid. In a preferred embodiment a heat engine is supported on the target end of the housing such that the target object and heat transfer fluid are the heat source of the heat engine.

This application claims the benefit under 35 U.S.C. 119(e) of U.S. provisional application Ser. No. 61/364,064, filed Jul. 14, 2010.

### FIELD OF THE INVENTION

The present invention relates to a solar heat collector including a focusing lens for focusing solar rays from the sun onto a target object surrounded by a heat exchanging fluid.

### BACKGROUND

It is known to use the rays from the sun to heat a fluid for various uses including the heating of buildings or performing various forms of useful work. Examples of solar boilers are described in U.S. Pat. Nos. 4,057,048 by Maine; 4,246,886 by Sitzlar; 4,056,093 by Barger; and 5,191,875 by Edling et al. Typically in the prior art, the heat transfer fluid is located in a large chamber such that the boiler area is vary large having potential for large convective losses. Furthermore, the large areas have limited capacity to heat the exchanger fluid to very elevated temperatures due to the potential for convective losses.

In other instances, energy is captured from the sun by focussing rays onto a solar cell. U.S. Pat. No. 6,881,893 by Cobert discloses one example of a solar collector in communication with a solar cell in which a focussing lens together with a reflective parabolic chamber direct sunlight towards the solar cell. No mechanism is provided for cooling the cell however and accordingly the amount of concentration of the solar rays must be limited to prevent overheating. Even when the cell does not overheat, the lack of any mechanism to capture the heating results in a considerable waste of energy in the form of wasted heat.

U.S. Pat. No. 6,653,551 by Chen discloses a further example of a solar cell in combination with a series of lenses or optical concentrators to direct concentrated solar rays onto a solar cell in communication with heat transfer fluid. The optical concentrators are in direct contact with the chamber locating the heat transfer fluid surrounding the solar cell so that there is still potential for considerable conductive heat losses through the optical concentrator. Furthermore, the overall combination of lenses is particularly complex so that it would be particularly difficult to vary the scale of the solar collector for different applications.

### SUMMARY OF THE INVENTION

According to one aspect of the invention there is provided a solar heat collector arranged for collecting solar rays from the sun, the solar heat collector comprising:

a housing comprising housing walls surrounding an insulated chamber spanning in a longitudinal direction between a receiving end and a target end of the housing;

a focusing lens spanning substantially perpendicularly to the longitudinal direction at the receiving end of the housing and arranged to focus solar rays inwardly towards a focal point adjacent the target end of the housing;

a target glass spanning substantially perpendicularly to the longitudinal direction at the target end of the housing adjacent the focal point of the focusing lens, the target glass being arranged to receive focused solar rays from the focusing lens therethrough;

the target glass forming a boundary wall between the insulated chamber and a target chamber which is arranged to receive a heat transfer fluid therein; and

a target object supported in the target chamber substantially at the focal point of the focusing lens so as to be arranged to be surrounded by the heat transfer fluid.

The solar collector of the present invention provides an improved boiler compared to prior art solar boilers in that the actual boiler chamber locating the heat transfer fluid therein is very small and concentrated at the focal point of a single focussing lens. By separating the target chamber and the focussing lens with an insulated chamber therebetween, heat losses from the boiler are minimized. The minimal size of the target chamber adjacent the focal point of the focussing lens permits very high temperatures to be achieved for optimal efficiency in energy recovery at the outlet of the boiler.

The improved configuration for heating a fluid surrounding the target object is also well suited for using the heated fluid as the heat source or working fluid in a heat engine such as a Stirling engine which is operable between a heat source and a cold sink. When there is provided a steering mechanism arranged to steer movement of the housing relative to a position of the sun, preferably the heat engine is supported on the housing for steering movement together with the housing such that the heat engine is arranged to be supported within a shadow of the housing relative to the sun.

Preferably a diameter of the target glass is smaller than a diameter of the focusing lens and a distance between the target glass and the focusing lens is greater than a radius of the focusing lens such that the target lens is near in diameter to a diameter of the focused solar rays arranged to be received therethrough.

The housing walls are preferably tapered linearly inwardly towards one another from the receiving end to the target end such that the housing walls are arranged to be substantially parallel to focused solar rays adjacent a perimeter of the focusing lens.

The target glass preferably comprises a high temperature resistant fused silica glass.

In some embodiments, the target object comprises a plurality of conductive filaments bundled together such that the heat exchange fluid is arranged to pass between the conductive filaments.

Preferably an insulating glass also spans parallel to the focusing lens at the receiving end of the housing such that the insulated chamber is fully surrounded by the insulating glass, the target glass and the housing walls spanning between the insulating glass and the target glass.

Preferably the focusing lens and the target glass are in sealing engagement with the housing walls about a full perimeter thereof.

In a preferred embodiment, the housing is supported on a supporting structure comprising:

a central support arranged to support the target end of the housing thereon for pivotal movement thereon such that the housing is pivotal relative to the central support about a vertical steering axis and about a horizontal tilt axis adjacent to the target end of the housing;

a circular track supported about the vertical steering axis of the central support;

a carriage member supported for movement about the circular track;

an extendible frame assembly connected between the carriage member and the housing at a location spaced from the target end of the housing towards the receiving end of the housing so as to support the receiving end of the housing on the carriage member for movement together along the circular track about the vertical steering axis; and

a steering mechanism comprising a first actuator adapted to control movement of the housing about the vertical steering axis and a second actuator adapted to control movement of the housing about the horizontal tilt axis such that the steering mechanism is adapted to steer the receiving end of the housing towards the sun such that the longitudinal direction of the housing remains aligned with the solar rays from the sun.

According to another embodiment of the invention, the target object may comprise a solar cell arranged to generate an electrical current in response to the solar rays focussed thereon.

The target object may alternatively comprise a heat absorbent material. In this instance there may be provided an inlet in communication with the target chamber so as to be arranged to supply heat transfer fluid to the target chamber and an outlet in communication with the target chamber to receive a heated flow of heat transfer fluid from the target chamber. In this instance, the target object also preferably comprises a plurality of conductive filaments tangled together such that the heat exchange fluid is arranged to pass therethrough between the conductive filaments.

The outlet may be configured such that the heated flow is passively driven by boiling of the fluid in the target chamber. More particularly, the outlet may comprise an outlet tube connected to a top end of the target chamber so as to be arranged to receive pockets of heat transfer fluid in a vapour state rising through the outlet tube in a manner which induces an upward flow of heat transfer fluid in a liquid state therewith to an auxiliary holding tank separate from the target chamber.

The inlet may comprise an inlet passage in open communication between a supply tank and a bottom end of the target chamber, the supply tank including a float valve arranged to maintain a level of heat transfer fluid in the supply tank substantially at an elevation of a top end of the target chamber.

Arranging the target object to comprise a conductive member fully surrounded by heat transfer fluid optimally transfers heat to the heat transfer fluid.

Alternatively, when the target object comprises a solar cell, the configuration of the target chamber provides efficient cooling to the solar cell with a minimum of losses in conveying the solar rays from the focussing lens to the solar cell due to the insulated chamber spanning the majority of the housing between the focussing lens and the target glass adjacent the focal point of the focussing lens.

According to another aspect of the present invention there is provided a solar heat collector arranged for collecting solar rays from the sun, the solar heat collector comprising:

a housing comprising housing walls surrounding an insulated chamber spanning in a longitudinal direction between a receiving end and a target end of the housing;

a focusing lens spanning substantially perpendicularly to the longitudinal direction at the receiving end of the housing and arranged to focus solar rays inwardly towards a focal point adjacent the target end of the housing;

a target glass spanning substantially perpendicularly to the longitudinal direction and arranged to receive focused solar rays from the focusing lens therethrough;

the target glass forming a boundary wall between the insulated chamber and a target chamber which is arranged to receive a heat transfer fluid therein;

a target object supported in the target chamber substantially at the focal point of the focusing lens so as to be arranged to be surrounded by the heat transfer fluid;

an inlet in communication with the target chamber so as to be arranged to supply heat transfer fluid to the target chamber; and

an outlet in communication with the target chamber to receive a heated flow of heat transfer fluid from the target chamber;

the outlet being configured such that the heated flow is passively driven by boiling of the fluid in the target chamber.

According to a further aspect of the present invention there is provided a solar heat collector arranged for collecting solar rays from the sun, the solar heat collector comprising:

a housing comprising housing walls surrounding an insulated chamber spanning in a longitudinal direction between a receiving end and a target end of the housing;

a focusing lens spanning substantially perpendicularly to the longitudinal direction at the receiving end of the housing and arranged to focus solar rays inwardly towards a focal point adjacent the target end of the housing;

a target glass spanning substantially perpendicularly to the longitudinal direction and arranged to receive focused solar rays from the focusing lens therethrough;

the target glass forming a boundary wall between the insulated chamber and a target chamber which is arranged to receive a heat transfer fluid therein; and

a target object supported in the target chamber substantially at the focal point of the focusing lens so as to be arranged to be surrounded by the heat transfer fluid;

the target object comprising a solar cell arranged to generate an electrical current in response to the solar rays focussed thereon.

Some embodiments of the invention will now be described in conjunction with the accompanying drawings in which:

### BRIEF DESCRIPTION OF THE DRAWINGS

FIG. 1 is sectional side elevational view of the solar heat collector;

FIG. 2 is a sectional view of the focusing lens of the solar heat collector;

FIG. 3 is a schematic representation of an operating system associated with the solar heat collector of FIG. 1;

FIG. 4 is an elevational view of a first embodiment of the target object in the target chamber;

FIG. 5 is an elevational view of a second embodiment of the target object in the target chamber;

FIG. 6 is an elevational view of a third embodiment of the target object in the target chamber;

FIG. 7 is a perspective view of the third embodiment of FIG. 6; and

FIG. 8 is a perspective view of a support structure and steering mechanism for the housing of the solar heat collector.

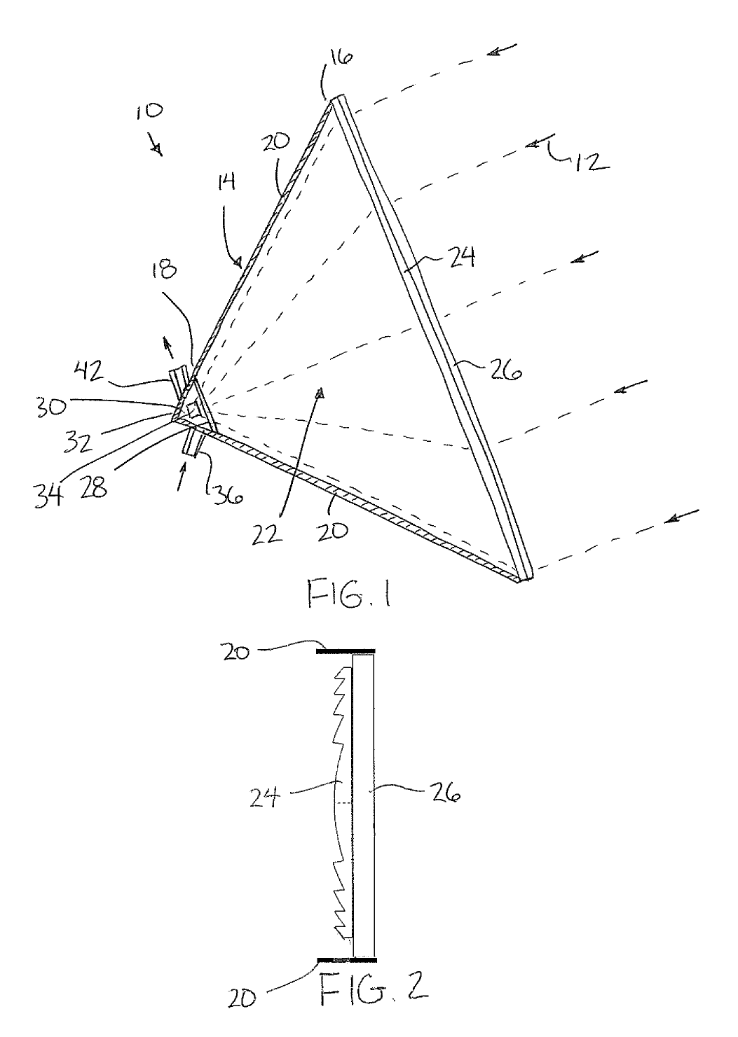

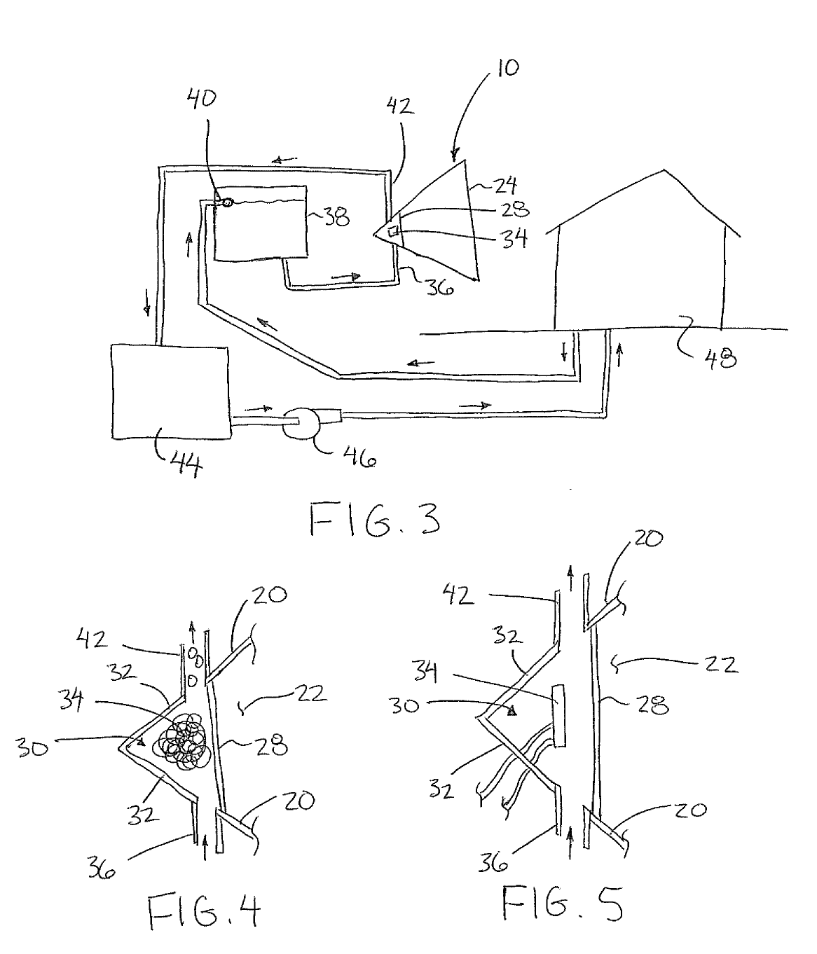

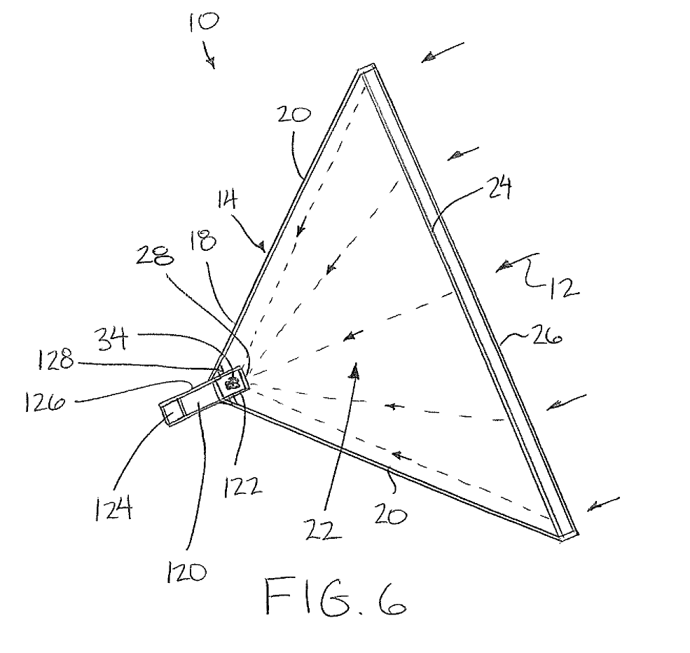

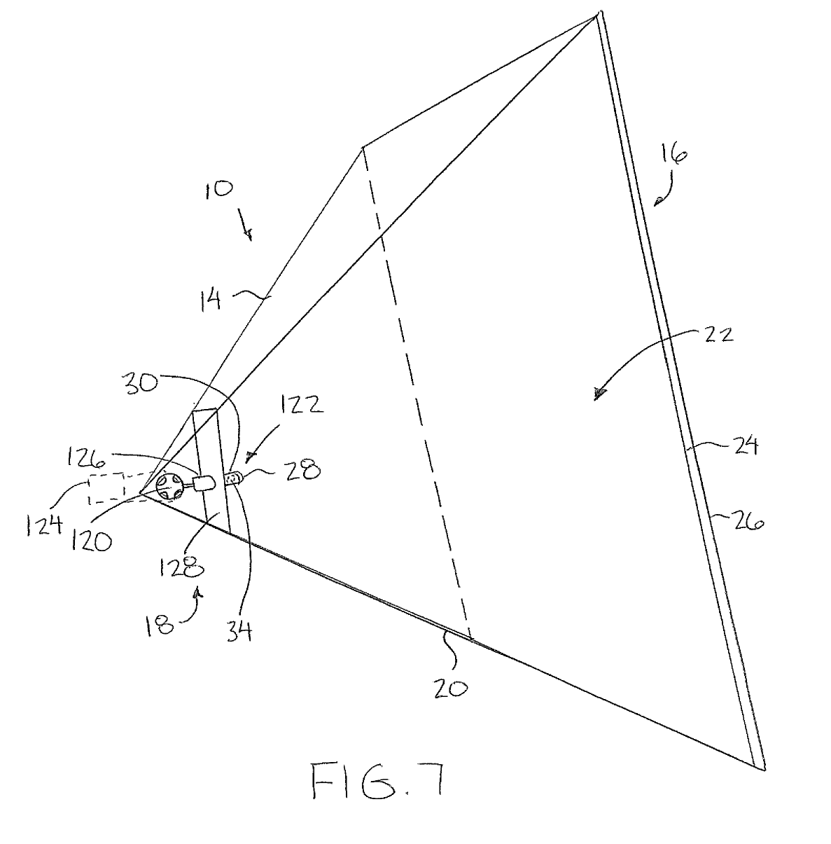

In the drawings like characters of reference indicate corresponding parts in the different figures.

### DETAILED DESCRIPTION

Referring to the accompanying figures there is illustrated a solar heat collector generally indicated by reference numeral 10. The collector 10 is arranged to collect solar rays 12 from the sun to convert the solar rays into a usable form of energy for performing useful work.

Although various embodiments are disclosed in the accompanying specification, the common features of the various embodiments will first be described.

The collector 10 includes a housing 14 extending generally in a longitudinal direction from a receiving end 16 to a target end 18. The housing is arranged to be aligned such that the longitudinal direction is generally aligned with the direction of the solar rays which are received into the receiving end 16 of the housing. The collector serves to direct the rays inwardly towards the target end 18 of the housing.

The housing includes insulated housing walls 20 which surround an insulated chamber 22 of the housing. The walls surround the chamber 22 on all sides spanning between the opposing receiving and target ends of the housing. The walls are tapered linearly inwardly towards one another from the receiving end to the target end. The walls may be any one of various shapes in cross section. When square in cross section the resulting walls are generally pyramidal in shape between the receiving end and the target end. Similarly when the walls are round in cross section, the housing is generally conical in shape between the receiving end and the target end.

A focusing lens 24 is mounted to fully span the receiving end 16 of the housing perpendicularly to the longitudinal direction. The focussing lens is similar in shape to the cross section of the housing walls so that the housing walls are joined to the focusing lens about the full perimeter thereof.

In the illustrated embodiment, the focusing lens 24 comprises a Fresnel lens arranged to focus the incoming solar rays in the longitudinal direction inwardly towards a common focal point at the target end 18 of the housing. The rays are focused inwardly by the Fresnel lens 24 such that the rays adjacent the perimeter of the lens are redirected inwardly substantially at the same angle as the slope of the housing walls 20 tapering inwardly from the receiving end to the target end. The boundary rays focussed by the lens 24 are thus substantially parallel to the housing walls.

An insulating glass 26 is mounted parallel and adjacent to the focussing lens to also fully span the receiving end of the housing perpendicularly to the longitudinal direction. The insulating glass and the focussing lens are sealed by a suitable resilient gasket about the full perimeter of the insulting glass to join the insulating glass to the housing walls such that the insulating glass forms a boundary of the insulated chamber 22 of the housing at the receiving end thereof. The focussing lens 24 is thus spaced inwardly towards the target end of the housing relative to the insulating glass. Alternatively, the insulating glass may be integrally formed with the focussing lens which is in turn similarly sealed about a full perimeter, using a similar sealing gasket.

A target glass 28 spans across the target end of the housing adjacent the focal point of the focussing lens 24 at a location spaced slightly inwardly from the focal point towards the receiving end of the housing. The diameter of the target glass 28 corresponds to the diameter of the housing at the target end such that the target glass is smaller in diameter than the focussing lens and is near in diameter to the diameter of the focussed rays at the cross section of the rays perpendicular to the longitudinal direction at the target glass location. By arranging the target glass 28 to be slightly larger than the corresponding focal plane of the focussed rays passing therethrough, substantially all of the focussed rays are directed through the target glass into an adjacent target chamber. The target glass 28 is uniform in thickness so as to be non-magnifying, transparent and clear and so as to form a boundary wall between the insulating chamber and the target chamber. Due to the proximity of the target glass to the focal point of the focussing lens, the target glass is spaced apart from the focussing lens by a distance which is resultingly much greater than a radius of the focussing lens. The target glass is formed of a high temperature resistant material, for example a fused silica glass.

The housing walls 20 are continuous beyond the target glass so as to project linearly from the focussing lens past the target glass to a common apex forming the other end of the target chamber 30 opposite the target glass. The portion of the housing walls extending beyond the target glass to the apex thus define side walls 32 of the target chamber which together with the boundary wall formed by the target glass fully surround the target chamber. The focal point of the focussing lens is arranged to be generally central within the target chamber.

A target object 34 is centrally located in the target chamber to be located at the focal point of the concentrated rays focussed by the lens 24 while being fully surrounded by a surrounding heat transfer fluid filling the target chamber, for example water or glycol. The target object 34 occupies a majority of the volume of the target chamber with the surrounding heat transfer fluid being arranged to capture substantially all of the heat from the target object.

As shown in FIG. 8, a suitable supporting structure supports the collector housing thereon such that the housing can be reoriented in the direction of the sun's rays. In particular a steering mechanism includes suitable sensors for sensing the orientation of the sun together with actuators responsive to the sensors to steer the receiving end of the housing to face towards the sun and align the longitudinal direction of the housing with the direction of the sun's rays.

The supporting structure 100 includes a central support 102 in the form of a vertical post. A circular track 104 is supported by a plurality of spokes extending radially outward from the post such that the track is coaxial about the central post spaced above the ground. A radial arm 106 is pivotally supported at an inner end on the post and extends radially outward to an outer end coupled to a carriage member 108 supported on rollers for rolling movement along the circular track 104 as the inner end of the radial arm 106 is pivoted about the vertical axis of the central post 102.

An extendable frame 110 is supported on the radial arm of the carriage member to extend generally upward to an upper end supporting a respective portion of the housing of the solar collector thereon. The extendable frame comprises a plurality of inter-connected links which are pivotal relative to one another in a scissor lift configuration between a retracted position and an extended position in which the overall height of the extendible frame 110 is greater than the retracted position.

The housing is supported on the support structure such that the target end of the housing is pivotally coupled to the central support 102 spaced above the circular track for pivotal movement of the housing about a vertical steering axis about the central support as well as about a horizontal tilt axis adjacent to the target end of the housing substantially at the vertical axis of the central support. The extendible frame 110 supports rollers at the upper end thereof for rolling engagement with a corresponding lowermost one of the side walls of the housing between the receiving and target ends. The rollers of the extendible frame thus engage the housing at a location spaced radially outward from the vertical axis adjacent the target end towards or adjacent to the receiving end of the housing.

The steering mechanism includes a first actuator adapted to control pivotal movement of the housing relative to the central support about the vertical steering axis thereof as well as a second actuator adapted to control movement of the housing about the horizontal tilt axis by controlling the extension and retraction of the extendible frame 110. By controlling the first and second actuators, the steering mechanism is adapted to steer the receiving end of the housing towards the sun such that the longitudinal direction of the housing remains aligned with the solar rays of the sun.

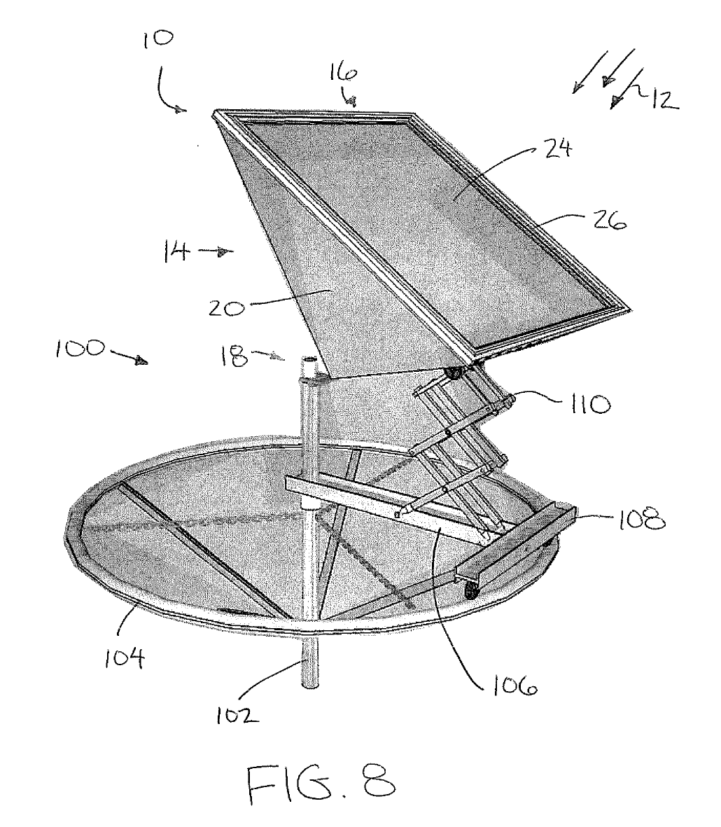

Turning now to FIGS. 6 and 7, according to a preferred embodiment, the target object in this instance acts as the heat source of a heat engine 120. The heat engine comprises a free piston-type Stirling engine for operation between a heat source 122 at a first end of a housing of the heat engine assembly and a cold sink 124 at an opposing second end of the housing of the engine. The heat engine comprises a free piston operated on a sterling cycle coupled to a linear generator within a common housing of the engine assembly. For example, one suitable heat engine is commercially available under the trademark name SunCatcher™ by Stirling Engine Systems Inc. located in Scottsdale, Ariz.

The housing of the heat engine assembly 120 is mounted on the housing of the solar collector at the target end thereof such that the heat engine is moveable together with the housing relative to the support structure 100, while the housing undergoes steering movement controlled by the first and second actuators noted above. By orienting the receiving end of the collector housing towards the sun, the steering mechanism ensures that the heat engine assembly, and particularly the cold sink 124 thereof remain in the shadow of the collector housing when supported at the target end of the housing.

At the first end of the engine housing, the target chamber of the solar collector is defined by walls of the engine housing 126 and the target glass 28 spanning the first end of the engine housing. Similarly to the embodiment of FIG. 4, described below, the target object includes a mass of conductive filaments 34 surrounded by heat transfer fluid in the target chamber such that the fluid can freely pass between the filaments bundled together. The conductive filaments are located at the focal point of the focusing lens 24 to be heated directly by solar rays which in turn heats the surrounding heat transfer fluid which may be arranged to exchange heat with the working fluid of the heat engine 120 or may comprise the working fluid of the engine directly. The target glass is sealed with respect to the surrounding walls of the engine housing 126. The insulated barrier 128 spans generally perpendicularly to the longitudinal direction of the collector housing radially outward from the walls of the engine housing 126 to the surrounding walls of the collector housing in sealed communication therebetween such that the remaining portion of the engine housing 126 extending rearward from the insulated barrier 128 opposite the receiving end of the housing is substantially isolated from the solar rays and the heat collected in the target chamber at the first end of the engine housing.

Turning now to the embodiments of FIGS. 4 and 5, the heat transfer fluid in this instance is circulated by a suitable operating system. In particular the system includes an inlet 36 in the form of an inlet tube in open communication with the bottom side of the target chamber as well as being in open communication with a supply tank 38. The open communication between the supply tank 38 and the target chamber results in the fluid level between the tank and the target chamber being maintained substantially equal. The supply tank 38 is in turn supplied by re-circulated fluid which is pumped therein. A float valve 40 maintains the level in the supply tank, and accordingly also in the target chamber, at the height of the top of the target chamber.

The operating system further comprises an outlet 42 in the form of an outlet tube in communication with the top of the target chamber to receive a heated flow of heat transfer fluid overflowing from the target chamber which is then directed into an auxiliary holding tank 44. The holding tank 44 is an insulated tank, for example supported below ground. In some instances however the tank may be supported above ground where it is impractical or there is no advantage to supporting the tank below ground.

As the fluid in the target chamber is heated by the solar rays heating the target object, the heated flow of fluid exits through the outlet. The heated flow is driven by arranging the diameter of the outlet tube to be small enough that pockets of heat transfer fluid which are heated into a vapour state which rise upwardly through the outlet tube drive a surrounding flow of heat transfer fluid in a liquid state together therewith upwardly for overflowing into the overflow holding tank 44. The heated flow is thus passively driven by boiling of the fluid in the target chamber without requiring an auxiliary pump between the target chamber and the holding tank 44.

In some instances, check valves may be required at the inlet and outlet to ensure that flow is directed through the outlet 42 as the heat transfer fluid heats up and pressure builds within the target chamber to passively drive the flow direction to the outlet. The use of check valves is particularly suited when operating the solar collector near the equator as the lens and flow direction through the target chamber may be near horizontal in orientation in this instance. Various emergency and safety control are also provided to prevent problems with overheating and to vent excess pressure if either the heat exceeds or the pressure exceeds prescribed limits of the controls.

Turning now more particularly to the embodiment of the target object as shown in FIG. 4, the target object in this instance comprises a mass of heat absorbent material. More particularly in the illustrated embodiment, the target object comprises stainless steel wool or like materials comprising a plurality of conductive filaments which are tangled together either as a matted mass or as a woven mass of filaments through which the heat transfer fluid is arranged to pass. The open coils of conductive filaments heat up as the concentrated solar rays are directed thereon at the focal point of the focussing lens with the heat being subsequently transferred to the surrounding heat transfer fluid flowing therethrough.

As shown in FIG. 5, according to another embodiment of the target object 34, the target object comprises a solar cell which is arranged to generate an electrical current in response to the solar rays being focussed thereon. Various commercially available types of solar cells can be used for effectively generating an electric current directly. In this instance, the heat transfer fluid can similarly be overflowed into a holding tank for use in producing other useful energy.

In either instance of the embodiments of FIG. 4 or 5, the heated fluid in the holding tank can be pumped by a suitable pump 46 to be directed to perform useful work such as heating a building 48 and the like. Once the heat has been extracted from the heat transfer fluid at the building 48, the fluid can be re-circulated back under pressure to the supply tank which supplies the fluid to the target chamber of the collector.

As described herein, the sunlight passes through the window which consists of insulating glass followed by a Fresnel lens, an insulated air chamber, then through the target glass. Generally the Fresnel lens and insulating glass are the same height and width. As sunlight passes through the window, it then passes through insulated air chamber. All edges of the window are sealed to prevent air leaks. The shape and size of the housing coincides with the shape of the window. If the window is round, the housing is cone shaped. If the window is square or rectangular, the housing is a four sided pyramidal shape. This provides optimal use of the suns energy as it is focused onto the target which is located precisely at the focal point of the lens. The target glass is round in shape, optically clear, slightly larger than the size of the magnified sunlight spot, and can withstand the high temperatures produced by magnified sunlight. Sealed to and behind the target, is the conical heat exchanger tank. It has hose connectors located at the top and at the bottom directly behind the target. Inside the heat exchanger tank, liquid (e.g. water) is fed into the bottom inlet, heated by the sun in the heat exchanger tank using a conductor (stainless steel wool) as an internal heating element. The water percolates out the top outlet. The window is fastened to the housing and there is a sealing gasket around the outer edge to prevent air leaks between the housing and the window. The target and parts are made of materials that can withstand high temperatures. Water is fed into the heat exchanger tank using a process like a toilet holding tank. The water holding tank sits a level that keeps the heat exchanger tank full. As water percolates out of the heat exchanger tank, it is replenished by the water holding tank and it is kept at the full level using a float valve. The solar collector is designed to track and follow the sun. When the water reaches boiling temperature, it flows into the storage tank where the water is then pumped into a home and used for heating purposes. Water is circulated from the storage tank back to the solar collector while the sun is out. There are many other uses for the invention like water purification, steam power generation, and others.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A solar heat collector arranged for collecting solar rays from the sun, the solar heat collector comprising:
a housing comprising housing walls surrounding an insulated chamber spanning in a longitudinal direction between a receiving end and a target end of the housing;
a focusing lens spanning substantially perpendicularly to the longitudinal direction at the receiving end of the housing and arranged to focus solar rays inwardly towards a focal point adjacent the target end of the housing;
a target glass spanning substantially perpendicularly to the longitudinal direction at the target end of the housing adjacent the focal point of the focusing lens, the target glass being arranged to receive focused solar rays from the focusing lens therethrough;
the target glass forming a boundary wall between the insulated chamber and a target chamber which is arranged to receive a heat transfer fluid therein; and
a target object supported in the target chamber substantially at the focal point of the focusing lens so as to be arranged to be surrounded by the heat transfer fluid.

2. The solar heat collector according to claim 1 wherein a diameter of the target glass is smaller than a diameter of the focusing lens.

3. The solar heat collector according to claim 1 wherein a distance between the target glass and the focusing lens is greater than a radius of the focusing lens.

4. The solar heat collector according to claim 1 wherein the target lens is near in diameter to a diameter of the focused solar rays arranged to be received therethrough.

5. The solar heat collector according to claim 1 wherein the housing walls are tapered linearly inwardly towards one another from the receiving end to the target end.

6. The solar heat collector according to claim 1 wherein the housing walls are tapered inwardly towards one another from the receiving end to the target end such that the housing walls are arranged to be substantially parallel to focused solar rays adjacent a perimeter of the focusing lens.

7. The solar heat collector according to claim 1 wherein the target glass comprises a high temperature resistant fused silica glass.

8. The solar heat collector according to claim 1 wherein the target object comprises a plurality of conductive filaments bundled together such that the heat exchange fluid is arranged to pass between the conductive filaments.

9. The solar heat collector according to claim 1 further comprising an insulating glass spanning parallel to the focusing lens at the receiving end of the housing, the insulated chamber being fully surrounded by the insulating glass, the target glass and the housing walls spanning between the insulating glass and the target glass.

10. The solar heat collector according to claim 1 wherein the focusing lens and the target glass are in sealing engagement with the housing walls about a full perimeter thereof.

11. The solar heat collector according to claim 1 further comprising a heat engine operable between a heat source and a cold sink, the heat transfer fluid comprising the heat source of the heat engine.

12. The solar heat collector according to claim 1 wherein there is provided a steering mechanism arranged to steer movement of the housing relative to a position of the sun and wherein the heat engine is supported on the housing for steering movement together with the housing such that the heat engine is arranged to be supported within a shadow of the housing relative to the sun.

13. The solar heat collector according to claim 1 wherein the target object comprising a solar cell arranged to generate an electrical current in response to the solar rays focussed thereon.

14. The solar heat collector according to claim 1 wherein the housing is supported on a supporting structure comprising:
a central support arranged to support the target end of the housing thereon for pivotal movement thereon such that the housing is pivotal relative to the central support about a vertical steering axis and about a horizontal tilt axis adjacent to the target end of the housing;
a circular track supported about the vertical steering axis of the central support;
a carriage member supported for movement about the circular track;
an extendible frame assembly connected between the carriage member and the housing at a location spaced from the target end of the housing towards the receiving end of the housing so as to support the receiving end of the housing on the carriage member for movement together along the circular track about the vertical steering axis; and
a steering mechanism comprising a first actuator adapted to control movement of the housing about the vertical steering axis and a second actuator adapted to control movement of the housing about the horizontal tilt axis such that the steering mechanism is adapted to steer the receiving end of the housing towards the sun such that the longitudinal direction of the housing remains aligned with the solar rays from the sun.

15. The solar heat collector according to claim 1 wherein the target object comprises a heat absorbent material and wherein there is provided an inlet in communication with the target chamber so as to be arranged to supply heat transfer fluid to the target chamber and an outlet in communication with the target chamber to receive a heated flow of heat transfer fluid from the target chamber.

16. The solar heat collector according to claim 15 wherein the target object comprises a conductive material.

17. The solar heat collector according to claim 16 wherein the target object comprises a plurality of conductive filaments tangled together such that the heat exchange fluid is arranged to pass therethrough between the conductive filaments.

18. The solar heat collector according to claim 15 wherein the outlet is configured such that the heated flow is passively driven by boiling of the fluid in the target chamber.

19. The solar heat collector according to claim 18 wherein the outlet comprises an outlet tube connected to a top end of the target chamber so as to be arranged to receive pockets of heat transfer fluid in a vapour state rising through the outlet tube in a manner which induces an upward flow of heat transfer fluid in a liquid state therewith to an auxiliary holding tank separate from the target chamber.

20. The solar heat collector according to claim 15 wherein the inlet comprises an inlet passage in open communication between a supply tank and a bottom end of the target chamber, the supply tank including a float valve arranged to maintain a level of heat transfer fluid in the supply tank substantially at an elevation of a top end of the target chamber.
